(19) United States
(12) Patent Application Publication
(10) Pub. No.: US 2017/0316364 A1
(43) Pub. Date: Nov. 2, 2017

(54) MEASURING LOCATE TECHNICIAN PERFORMANCE FOR QUALITY ASSURANCE

(71) Applicant: Alan Haddy, Naples, FL (US)

(72) Inventor: Alan Haddy, Naples, FL (US)

(21) Appl. No.: 15/144,423

(22) Filed: May 2, 2016

(51) Int. Cl. G06Q 10/06

(52) U.S. Cl. CPC G06Q 10/06398; G06Q 10/06395

(57) ABSTRACT

A method on a computing device for measuring the quality of a buried asset location procedure for quality assurance is provided. The method includes storing a plurality of best practice instruction records, receiving process and sensor data from a field technician that has performed a buried asset location procedure, calculating the sub-metrics based on the field technician's process and device data, defining a sigmoid function for each sub-metric, converting each of the sub-metrics to a normalized value using the sigmoid function corresponding to said sub-metric, storing weight values corresponding to each sub-metric; calculating a main metric P representing the quality of the field technician's buried asset location procedure and technique based on the sub-metrics, searching for matching best practice instruction records that correspond to the main metric and sub-metrics, and displaying the description of a program for best practice instruction of the matching best practice instruction records.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the detection and identification of buried assets (i.e., underground utility lines) and, more specifically, to processes for improving the procedure and technique of detecting and identifying buried assets.

### BACKGROUND

Utility lines, such as lines for telephones, electricity distribution, natural gas, cable television, fiber optics, Internet, traffic lights, street lights, storm drains, water mains, and wastewater pipes, are often located underground. Utility lines are referred to as “buried assets” herein. Consequently, before excavation occurs in an area, especially an urban area, an excavator is typically required to clear excavation activities with the proper authorities and service providers. The clearance procedure usually requires that the excavator contact a central authority (such as “One Call”, “811” and “Call Before You Dig,” which are well known in the art) which, in turn, sends a notification to the appropriate utility companies. Subsequently, each utility company must perform a buried asset detection procedure, which includes having a field technician visit the proposed excavation site, detecting the relevant buried assets and physically marking the position of the buried asset using temporary paint or flags.

Usually, a field technician visiting a proposed excavation site utilizes a portable electronic device known as a pipe or cable locator, which may be a commercial, off-the-shelf, two-part receiver/transmitter kit that is employed to detect and identify the position of the buried assets. This is typically achieved by connecting the transmitter part to a suitable connection point (i.e., pedestal, hydrant, manhole, removable cover, lid, junction box or other access point) of the buried asset, wherein the transmitter sends a signal of a specific frequency onto the buried conductor. Subsequently, the receiver device is “tuned” to the specific frequency in order to locate the resulting electromagnetic signal radiating from the buried conductor, thus enabling the position and route of the buried pipe/cable to be marked with paint or flags above surface.

The aforementioned buried asset location procedure, however, takes time and training to master. There are a variety of techniques that the field technician must learn in order to perform buried asset location procedures in a way that meets best practice standards. Often, the field technician may spend a significant amount of time at a training facility learning proper location techniques and then perform an apprenticeship afterwards. After completing the aforementioned training and apprenticeship, field technicians then commence work detecting and identifying buried assets.

Once field technicians begin work detecting and identifying buried assets, however, there is little data that managers and administrators can view to determine the performance of a field technician or the quality of the data collected by him Managers do have access to the buried asset data points collected by field technicians, but this data only tells part of the story. Some companies have even used geo-locational data to measure how much the field technician has travelled in a given day or during a given project. But again, this data only reveals one aspect of a field technician's productivity. As such, there is an unknown or blackout period during a typical field technician's work day when managers or administrators have no data against which to evaluate the field technician's performance. Consequently, there is currently no way for a manager or administrator to get a complete picture of a field technician's performance, or the quality of the data collected by him, during a buried asset locate procedure.

Therefore, a need exists for improvements over the prior art, and more particularly for more efficient methods and systems for measuring the performance of field technicians, and the quality of the data they collected, during a buried asset locate procedure.

### SUMMARY

A method and system for measuring quality of a buried asset location procedure for quality assurance is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method on a computing device for measuring quality of a buried asset location procedure for quality assurance is provided that solves the above-described problems. The method includes storing, in an attached database, a plurality of best practice instruction records, wherein each record includes a description of a program for best practice instruction, a main metric and one or more sub-metrics representing quality of a field technician's buried asset location procedure and technique, wherein said program for best practice instruction addresses educational and process deficiencies identified by said main metric and sub-metrics; receiving, via a communications network communicatively coupled with the computing device, the following data from a field technician that has performed a buried asset location procedure: a) a group of buried asset data points corresponding to a particular buried asset, wherein each of said buried asset data points includes geographical location data and a time and date stamp, b) metadata pertaining to the group of buried asset data points, and c) a unique identifier for the field technician; calculating the following sub-metrics based on the group of buried asset data points and said metadata: i) electromagnetic locate compliance (E), which indicates the field technician's compliance with predefined buried asset location procedure standard, ii) session speed (S), which indicates an amount of time taken by the field technician to acquire the group, iii) record density (R), which indicates a density of the group within a geographical area, iv) data quality (D), which indicates accuracy and precision of the group, v) useful additions (A), which includes written comments and images entered by the field technician and which correspond to the group, vi) travel time efficiency (T), which indicates an amount of time between reception of a ticket to locate the group and the time and date of acquisition of the group, and vii) utility type efficiency (U), which indicates an amount of time taken to locate each buried asset type; for each of the sub-metrics E, S, R, D, A, T and U, defining a sigmoid function described by at least one quantity-value pair entered by an administrator, wherein a quantity-value pair comprises a quantity for a sub-metric paired with a resulting performance value; converting each of the sub-metrics E, S, R, D, A, T and U to a normalized value by entering each sub-metric value into the sigmoid function corresponding to said sub-metric; storing the following weight values: w_{E}, w_{S}, w_{R}, w_{D}, w_{A}, w_{T}, w_{U}, wherein W_{E} is a weight value corresponding to E, w_{S} is a weight value corresponding to S, w_{R} is a weight value corresponding to R, w_{D} is a weight value corresponding to D, w_{A} is a weight value corresponding to A, w_{T} is a weight value corresponding to T, and w_{U} is a weight value corresponding to U; calculating a main metric P representing the quality of the field technician's buried asset location procedure and technique, wherein the main metric P is calculated as:

$$P = \frac{{w}_{E} E + {w}_{S} S + {w}_{R} R + {w}_{D} D + {w}_{A} A + {w}_{T} T + {w}_{U} U}{{w}_{E} + {w}_{S} + {w}_{R} + {w}_{D} + {w}_{A} + {w}_{T} + {w}_{U}}$$

searching the attached database for one or more matching best practice instruction records with a main metric and sub-metrics that matches, within predefined parameters, the main metric P that was calculated and the sub-metrics E, S, R, D, A, T and U; and displaying the description of a program for best practice instruction of the one or more matching best practice instruction records.

### BRIEF DESCRIPTION OF THE DRAWINGS

The accompanying drawings, which are incorporated in and constitute a part of this disclosure, illustrate various example embodiments. In the drawings:

FIG. 1 is a diagram of an operating environment that supports a method and system for measuring quality of a buried asset location procedure for quality assurance, according to an example embodiment;

FIG. 2 is a diagram showing the data flow of the general process for measuring quality of a buried asset location procedure for quality assurance, according to an example embodiment;

FIG. 3 is a flow chart showing the control flow of the process for measuring quality of a buried asset location procedure for quality assurance, according to an example embodiment;

FIG. 4 is an illustration showing the process of logging buried asset data points, according to an example embodiment;

FIG. 5 is an illustration showing the process of calculating density of buried asset data points, according to an example embodiment;

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The claimed subject matter improves over the prior art by providing a more efficient, automated and precise way of measuring the performance of a field technician during a buried asset locate procedure, as well as the quality of the data he collects. The example embodiments log a variety of data collected during a buried asset locate procedure and then subsequently provides that data to a system that determines the performance of the field technician, as well as the data collected. The example embodiments leverage the vast amount of data that can be collected during a buried asset locate procedure to identify deficiencies in a field technician's performance, so as to recommend ways to remediate the field technician's performance with educational or best practices instruction. The disclosed embodiments reduce or eliminate the unknown or blackout period during a field technician's work day when managers or administrators have no data against which to evaluate a field technician's performance Hence, the example embodiments provide a complete picture of a field technician's performance, and the quality of the data collected by him, during a buried asset locate procedure.

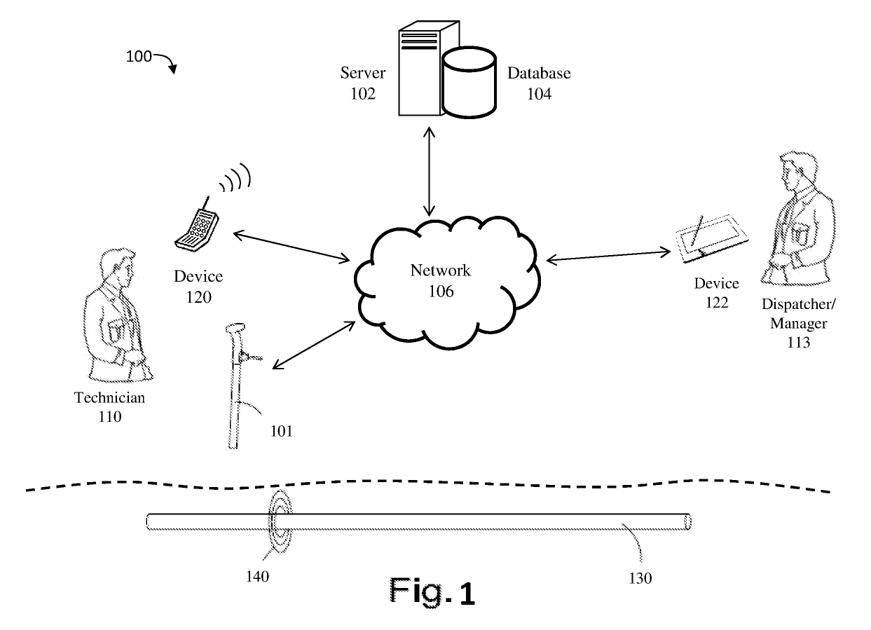

FIG. 1 is a diagram of an operating environment 100 that supports a method and system for measuring quality of a buried asset location procedure for quality assurance. The server or computing device 102 may be communicatively coupled with a communications network 106, according to an example embodiment. The environment 100 may comprise mobile computing devices 120, 122, which may communicate with computing device 102 via a communications network 106. Mobile computing devices 120, 122 may comprise a cellular/mobile telephone, smart phone, tablet computer, laptop computer, handheld computer, wearable computer, or the like. Devices 120, 122 may also comprise other computing devices such as desktop computers, workstations, servers, and game consoles, for example. The mobile computing devices 120, 122 may be connected either wirelessly or in a wired or fiber optic form to the communications network 106. Communications network 106 may be a packet switched network, such as the Internet, or any local area network, wide area network, enterprise private network, cellular network, phone network, mobile communications network, or any combination of the above.

FIG. 1 also shows a locator 101, which detects and measures radio frequency and/or electromagnetic signals 140 emanating from a buried asset 130. In one embodiment, locator 101 includes all of the functions of a conventional locator device, which is well known in the art. Locator 101 is also connected either wirelessly or in a wired or fiber optic form to the communications network 106. Locator 101 may comprise a computing device 600.

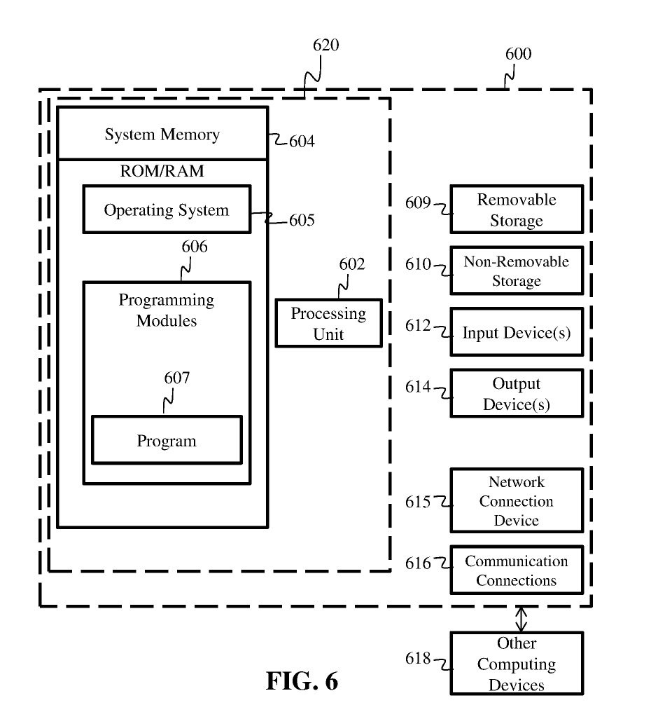

The environment 100 shows that mobile computing device 120 is operated by a technician or operator 110 (i.e., a field technician). Device 122 may also be operated by a manager or a dispatcher 113 that dispatches or provides support to a technician 110 (alternatively, the technician 110 may be the same person as technician 113). Server 102, locator 101 and devices 120, 122 may each comprise a computing device 600, described below in greater detail with respect to FIG. 6.

In another embodiment, the devices 120, 122 also calculate current geographical position (otherwise referred to as geographical location data) using an on-board processor or a connected processor. In one embodiment, the devices 120, 122 may calculate current position using a satellite or ground based positioning system, such as a Global Positioning System (GPS) system, which is a navigation device that receives satellite or land based signals for the purpose of determining the device's current geographical position on Earth. A GPS receiver, and its accompanying processor, may calculate latitude, longitude and altitude information. In this document, the term GPS is used generally to refer to any global navigation satellite system, such as GLONASS, GALILEO, GPS, etc. In this embodiment, a radio frequency signal is received from a satellite or ground based transmitter comprising a time the signal was transmitted and a position of the transmitter. Subsequently, the devices 120, 122 calculate current geographical location data of the device based on the signal. In another embodiment, the devices 120, 122 calculate current geographical location using alternative services, such as control plan locating, GSM localization, dead reckoning, or any combination of the aforementioned position services. The term spatial technologies or spatial processes refers generally to any processes and systems for determining one's position using radio signals received from various sources, including satellite sources, land-based sources and the like.

Computing device 102 includes a software engine that delivers applications, data, program code and other information to networked devices, such as 120, 122. The software engine of device 102 may perform other processes such as transferring multimedia data in a stream of packets that are interpreted and rendered by a software application as the packets arrive. FIG. 1 further shows that device 102 includes a database or repository 104, which may be a relational database comprising a Structured Query Language (SQL) database stored in a SQL server. Mobile computing devices 120, 122 may also include their own database, either locally or via the cloud. The database 104 may serve buried asset data, buffer zone data, portable transmitter hookup data, as well as related information, which may be used by device 102 and mobile computing devices 120, 122.

Device 102, mobile computing devices 120, 122 and locator 101 may each include program logic comprising computer source code, scripting language code or interpreted language code that perform various functions of the disclosed embodiments. In one embodiment, the aforementioned program logic may comprise program module 607 in FIG. 6. It should be noted that although FIG. 1 shows only two mobile computing devices 120, 122, one locator 101 and one device 102, the system of the disclosed embodiments supports any number of servers, locators and mobile computing devices connected via network 106. Also note that although device 102 is shown as a single and independent entity, in one embodiment, device 102 and its functionality can be realized in a centralized fashion in one computer system or in a distributed fashion wherein different elements are spread across several interconnected computer systems.

Environment 100 may be used when devices 120, 101 engage in buried asset detection activities that comprise reading, generating, and storing buried asset data and related information. Various types of data may be stored in the database 104 of device 102 (as well as data storage on devices 120, 122 and locator 101) with relation to a buried asset that has been detected and located. For example, the database 104 (or devices 120, 122 and locator 101) may store one or more records for each buried asset, and each record may include one or more buried asset data points. A buried asset data point may include a current time, a textual map address, and location data or position data, such as latitude and longitude coordinates, geographical coordinates, an altitude coordinate, or the like. A buried asset data point may also include depth measurement data, electromagnetic signal measurement data (such as electrical current measurement data, resistance measurement data, impedance measurement data, electrical signal magnitude measurement data, electrical signal frequency measurement data, electrical signal voltage measurement data, etc.), direction data and orientation data. Each record may include data for one buried asset data point.

A buried asset data point may also include a precision data value corresponding to any piece of information associated with a buried asset data point, such as the geographical coordinate or. A precision data value is a value that represents the quality or level of precision of a piece of information, such as a geographical coordinate. All sensors and devices that read physical quantities have a certain amount of measurement error or observational error. A precision data value represents the amount or magnitude of the measurement error or observational error of a sensor or device at one time. In one embodiment, a precision data value is a numerical value, such as a real number from 0 to 1.0 (with a variable number of decimal points) wherein zero represents perfect precision, 0.5 represents a precision that is 50% off from a true value, 0.75 represents a precision that is 75% off from a true value, etc. In another embodiment, a precision data value is an alphanumeric value (such as a word or other ASCII string) that corresponds (according to a lookup table or other correspondence table) to a predefined amount of precision. In another embodiment, a precision data value is any set of values that may be sorted according to ascending or descending value. Thus, in this embodiment, precision data values may have ascending and descending values.

In one embodiment, the precision data value is inversely proportional to the level of precision of quality of a piece of information, such as a geographical coordinate. Thus, when there is a large margin of error or a low confidence level in a piece of information, then the precision data value is high and the quality or level of precision of the information is low. Conversely, when there is a small margin of error or a high confidence level in a piece of information, then the precision data value is low and the quality or level of precision of the information is high.

With regard to geographical coordinates, HDOP, VDOP, PDOP, and TDOP values (Horizontal, Vertical, Positional and Time Dilution of Precision, respectively) are precision data values well known in the art for representing the quality or level of precision of a geographical coordinate. Also with regard to geographical coordinates, values representing the quality or level of precision of a geographical coordinate may rely on whether a differential correction technique (such as differential GPS) was used in calculating the coordinate. The Differential Global Positioning System (DGPS) is an enhancement to Global Positioning System that provides improved location accuracy. DGPS uses a network of fixed, ground-based reference stations to broadcast the difference between the positions indicated by the satellite systems and the known fixed positions. As such, if DGPS was used to calculate a geographical coordinate, then the precision data value of the coordinate may reflect that fact. For example, the precision data value may indicate higher accuracy if DGPS was used.

In one embodiment, Precise Point Positioning (PPP) is used to generate a precision data value representing the quality or level of precision of a geographical coordinate. PPP is a global navigation satellite system positioning method to calculate precise positions up to few centimeter level using a single receiver in a dynamic and global reference framework. The PPP method combines precise clocks and orbits calculated from a global network to calculate a precise position with a single receiver.

A buried asset data point may also include a precision data value corresponding to any piece of information associated with a buried asset data point, such as a current time, a textual map address, depth measurement data, electrical signal measurement data (such as electrical current measurement data, signal strength data, resistance measurement data, impedance measurement data, electrical signal magnitude measurement data, electrical signal frequency measurement data, electrical signal voltage measurement data, electromagnetic vector data, etc.), direction data (left or right indicators that direct the technician to the location of the buried asset), orientation data, and location data or position data, such as latitude and longitude coordinates, geographical coordinates, an altitude coordinate, or the like.

Database 104 may also include a plurality of best practice instruction records. A best practice instruction record includes a description of a program for best practice instruction, a main performance metric and one or more sub-metrics representing quality of a field technician's buried asset location procedure and technique, wherein said program for best practice instruction addresses educational and process deficiencies identified by said main metric and sub-metrics. The description may be a text, audio and/or video description of coursework, instructions, videos, educational materials or other materials targeted to address certain educational and process deficiencies in a filed technician. A best practice instruction record may also include the actual coursework, instructions, videos, educational materials or other materials for viewing by a field technician for which said materials address educational and process deficiencies.

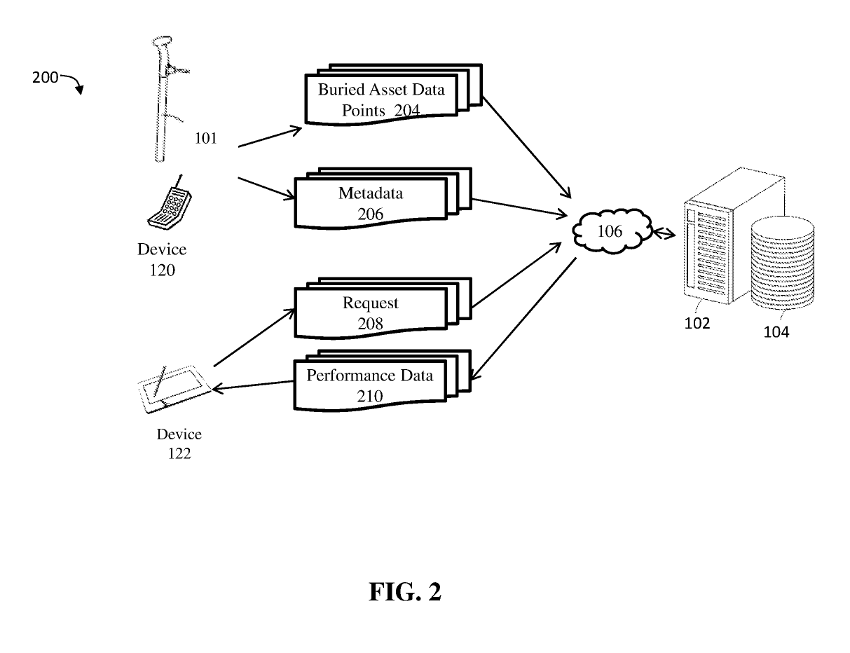

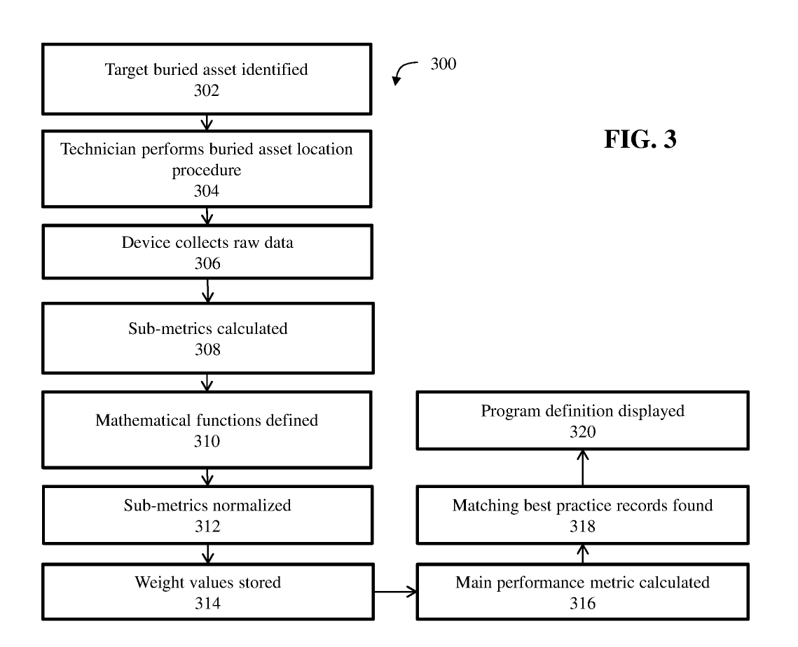

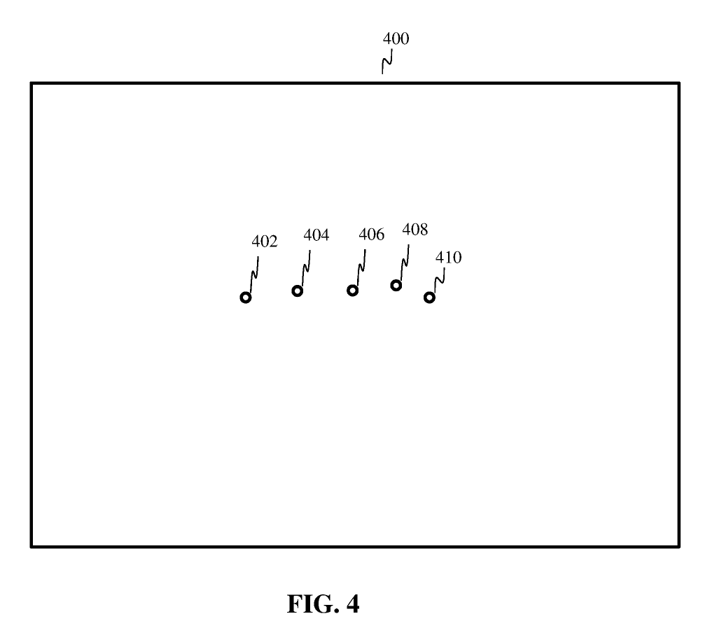

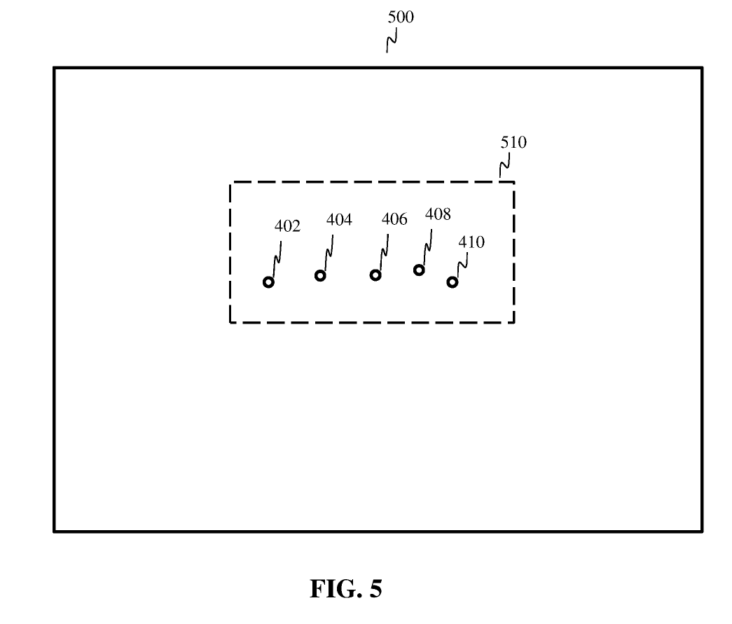

FIG. 3 is a flow chart showing the control flow of the process 300 for measuring quality of a buried asset location procedure for quality assurance, according to an example embodiment. Process 300 describes the steps that being to occur when the locate technician 110 detects and identifies a particular target buried asset 130 that may be located within an area including multiple buried assets. The process 300 is described with reference to FIG. 2, which shows the general data flow 200 of the process 300, as well as FIGS. 4, and 5.

Prior to the beginning of the process 300, it is assumed that stored in database 104 is a plurality of best practice instruction records, wherein each record includes a description of a program for best practice instruction, a main metric and one or more sub-metrics representing quality of a field technician's buried asset location procedure and technique, wherein said program for best practice instruction addresses educational and process deficiencies identified by said main metric and sub-metrics.

Process 300 starts in earnest with step 302 wherein a target buried asset 130, which is the buried asset the technician 110 is seeking, is identified to the technician 110 and/or the server 102. In one embodiment, this step is accomplished when the device 102 receives a work ticket specifying that a buried asset locate procedure must be performed at a particular location for a particular buried asset identified by a unique identifier, type of buried asset, expected reading for buried asset, or the like. In another embodiment, this step is accomplished by the server 102 receiving a command from the technician 110, wherein the device 120 sends a unique identifier for the target buried asset 130 to the server 102 via network 106. Step 302 may be performed while the technician 110 is located on site in the vicinity of the target buried asset, while the technician is at work or headquarters, while the technician is at home, on the road, or at any other location. In another embodiment, step 302 may be performed automatically when the technician 110 arrives at the vicinity of the target buried asset, the device 120 sends its current geographical location to the device 102 and the device 102 determines which buried assets are located at said location.

In step 304, the technician 110 performs a buried asset location procedure using his locator 101/device 120 and generates buried asset data and/or buried asset data points 204, which are uploaded to the device 102 via network 106. The device 101 may utilize an antenna array to read raw analog signals 140 emanating from the target buried asset 130. Based on the data it has received and calculated, device 101 calculates one or more buried asset data points 204 for the target buried asset. Upon generating the buried asset data points, the technician may place physical markings on the ground corresponding to each point, such as a flag, a paint mark or a combination of the two. The device 102 receives the buried asset data and/or buried asset data points 204 and creates records in the database 104 to hold said data.

In step 306, the device 102 collects the following raw data from the field technician device that has performed a buried asset location procedure: a) a group of buried asset data points corresponding to a particular buried asset, wherein each of said buried asset data points includes electromagnetic locate data, geographical location data and a time and date stamp, b) metadata pertaining to the group of buried asset data points, and c) a unique identifier for the technician. The metadata refers to data about the group of buried asset data points, such as spatial data points (e.g., GPS data, measured longitude/latitude, universal time stamp, GPS accuracy, precision data value, etc.) captured when locating and pinpointing the buried asset's location, on-site activity time data derived from a suitable clock on the locate device, data pertaining to when the field technician departed from his initial location to arrive at the location of the buried asset data points, the commuter traffic on the roads the field technician took to arrive at the location of the buried asset data points, device motion sensor data (garnered from an accelerometer, gyroscope, compass, and/or rotation or tilt sensor), device mode selection data, electromagnetic signal response data and data about the quality and accuracy of the GPS signal. The raw data collected in step 306 is then used at a later point to generate metrics that represent the technician's performance during said buried asset location procedure.

Each pipe/cable locator device 101 has various modes that the field technician selects depending on type of utility, type of environment, etc. These device mode selections include frequency selections to match transmitter selection, peak signal mode, null signal mode, peak and null signal modes simultaneously, line versus sonde/probe mode. Said device mode selections may define a locate device operating mode. Each pipe/cable locator device 101 may also collect electromagnetic (EM) signal response data, which indicates wow the locator device is responding to the electromagnetic signals (140) it is detecting and processing, as well as signal strength, signal direction (left right of target), system gain control, phase (direction) of signal, measured depth, measured current, etc.

Next, in step 308, the device 102 calculates sub-metrics based on the raw data collected in step 306. In this step, the device 102 calculates the following raw sub-metrics based on the group of buried asset data points and said metadata collected in step 306: i) electromagnetic locate compliance (E), which indicates the technician's compliance with predefined buried asset location procedure standard, ii) session speed (S), which indicates an amount of time taken by the technician to acquire the group, iii) record density (R), which indicates a density of the group within a geographical area, iv) data quality (D), which indicates a precision of the group, v) useful additions (A), which includes written comments and photographs entered by the technician and which correspond to the group, vi) travel time efficiency (T), which indicates an amount of time between reception of a ticket to locate the group and the time and date of acquisition of the group, and vii) utility type efficiency (U) which indicates the amount of time taken to locate each individual buried asset type.

In one embodiment, in step 308, electromagnetic locate compliance (E), which indicates the field technician's compliance with predefined buried asset location procedure standards, is calculated by analyzing the locate device's operating modes, electromagnetic (EM) signal response data, spatial (GPS) data and on-board motion sensors. Session speed (S), which indicates an amount of time taken by the field technician to acquire the group, is calculated based on a time and date when a first buried asset data point of the group was taken, and a time and date when a last buried asset data point of the group was taken. I.e., the time between first spatial/GPS point captured and the last, or the total time the field technician was on-site. Note, there is a difference between the session speed, and group session time, which is the time of the total locate session, as well as utility type efficiency (see “U” below) and time taken to locate an asset type such as a gas pipe versus a telecom cable.

Record density (R), which indicates a density of the group within a geographical area, is calculated based on a number of buried asset data points in the group and a size of a geographical area in which said buried asset data points are located. Data quality (D), which indicates accuracy and precision of the group, is calculated based on a precision data value associated with the group of buried asset data points. Data quality may refer to the PPP, HDOP, VDOP, PDOP, and TDOP items described above. Data quality may also refer to electromagnetic signal response data, i.e., the evaluation of signals received from the locator device.

Travel time efficiency (T) is calculated based on an amount of time between reception of a ticket to locate the group and the time and date of acquisition of the last buried asset data point of the group, and utility type efficiency (U), which indicates an amount of time taken to locate each buried asset type during the locate session and is calculated by a suitable clock on the locate device measuring the individual time taken to locate each buried asset type (such as gas, water, telecom lines).

The initial data collected in step 306 and the data calculated in step 308 comprise the quality control aspect of the claimed subject matter. Quality control is a process by which entities review the quality of all factors involved in production by the field technicians. Part of said process includes automated or non-automated inspection or review of the data collected in step 306 and the data calculated in step 308 to determine whether said data meets industry standards.

Returning to the process 300, the raw sub-metrics calculated in step 308 have their own individual units of measurement. For example, session speed (S) may be in meters per second and record density (R) may be in units per square meter. It would be instructive to normalize the sub-metrics E, S, R, D, A, T and U to a unit-less (i.e., no dimension) scale, such as a scale between 0 and 1 (or bounded between 0 and 1). An additional reason to normalize the sub-metrics E, S, R, D, A, T and U is to convert the sub-metrics to a value that represents the technician's performance during said buried asset location procedure. For example a normalized session speed (S) value of 0.1 indicates poor performance but a session speed (S) value of 0.9 indicates good performance The selected scale, however, must be able to account for raw sub-metric values that may be unexpected or constitute outliers. That is, the selected scale must result in cogent normalized values, regardless of how large or small is the raw sub-metric value. Mathematically, the domain of the selected scale must be able to account for all possible raw sub-metric values.

Thus, in step 310, a mathematical function is defined for the purpose of normalizing the sub-metrics E, S, R, D, A, T and U, wherein the normalized value also represents the technician's performance during said buried asset location procedure and wherein the normalized value is bounded between two values (such as 0 and 1). In step 310, for each of the sub-metrics E, S, R, D, A, T and U, the device 102 defines a sigmoid function described by at least one quantity-value pair entered by an administrator (or other person), wherein a quantity-value pair comprises a quantity for a sub-metric paired with a resulting performance value. A sigmoid function is a bounded (i.e., having lower and upper bounds for y-values), differentiable real function that is defined for all real input values and has a positive derivative at each point. A sigmoid function has an S-shaped curve (sigmoid curve). One example of a sigmoid function is the hyperbolic tangent function f(x)=tanh(x).

In one embodiment, the following formula is used to define the sigmoid function that is used to normalize the sub-metrics E, S, R, D, A, T and U, wherein the resulting normalized value also represents the technician's performance during said buried asset location procedure:

f (x)=½+½ tanh (αx+c) (1)

wherein the values α, c are derived from values entered by an administrator (i.e., quantity-value pairs), wherein said values represent the administrator's notions of what constitutes poor, average and good performances and practice. The values entered by an administrator may comprise at least one quantity-value pair for formula (1) above, wherein a quantity-value pair comprises a quantity for a sub-metric paired with a resulting performance value. Taking record density (R) as an example, the administrator may believe that a record density (R) of 15 m (which would be the x-input to formula (1) above) should result in a y-value (i.e., f(x)) of 0.01 (i.e., a poor performance), while a record density (R) of 3 m (which would be the x-input to formula (1) above) should result in a y-value (i.e., f(x)) of 0.99 (i.e., a good performance). The values 15 and 0.01, and 3 and 0.99 are the quantity value pairs referred to above. Each quantity-value pair, when input into formula (1) above, results in a formula with two unknown variables—α, c. Therefore, two quantity-value pairs, when input into formula (1) above, allows one to mathematically derive the value of the two unknown variables—α, c. Therefore, the input of two quantity-value pairs from an administrator allows for the derivation of variables α, c, which results in formula (1) being fully defined and representing the administrator's notions of what constitutes poor, average and good performances. Once formula (1) is fully defined for each sub-metric, it can be used to normalize each of the sub-metrics E, S, R, D, A, T and U.

In one alternative embodiment, instead of having the values α, c derived from values entered by an administrator (i.e., quantity-value pairs), the values α, c are derived from empirical data collected from a statistically relevant sample of other field technicians. In this alternative embodiment, the values α, c are derived from quantity-value pairs that reflect what constitutes poor, average and good performances and practice, according to a normal distribution of data collected from a statistically relevant sample of other field technicians. Taking record density (R) as an example, the normal distribution of empirical data may indicate that a record density (R) of 15 m (which would be the x-input to formula (1) above) results in a y-value (i.e., f(x)) of 0.01 (i.e., a poor performance), while a record density (R) of 3 m (which would be the x-input to formula (1) above) results in a y-value (i.e., f(x)) of 0.99 (i.e., a good performance).

In step 312, the server 102 converts the sub-metrics E, S, R, D, A, T and U to a normalized value by entering each sub-metric value (calculated in step 308) into the sigmoid function corresponding to said sub-metric. Taking session speed (S), for example, the raw session speed (S) value calculated in step 308 is entered into the sigmoid function defined for session speed (S) in step 310 above. The resulting value is the normalized value for session speed (S), wherein the normalized value also represents the technician's performance during said buried asset location procedure (according to the administrator's notions of what constitutes poor, average and good performances).

Next, in step 314, the device 102 stores the following weight values entered by an administrator: w_{E}, w_{S}, w_{R}, w_{D}, w_{A}, w_{T}, w_{U} wherein w_{E} is a weight value corresponding to E, w_{S} is a weight value corresponding to S, w_{R} is a weight value corresponding to R, w_{D} is a weight value corresponding to D, w_{A} is a weight value corresponding to A, w_{T} is a weight value corresponding to T, and w_{U} is a weight value corresponding to U. The weight values above may be entered by an administrator, and the weight values define the relative importance of each of the sub-metrics E, S, R, D, A, T and U. For example, in a given calendar quarter, managers or administrators may decide that session speed (S) is of greater importance, and therefore the w_{S} weight value corresponding to S in increased, in relation to other weight values. In another example, in a given calendar quarter, managers or administrators may decide that session speed (S) is of less importance, and therefore the w_{S} weight value corresponding to S in decreased, in relation to other weight values.

In step 316, the server 102 calculates a main metric representing quality of the technician's buried asset location procedure, wherein the main metric combines the sub-metrics E, S, R, D, A, T and U , as well as the weight values entered by an administrator, and wherein the main performance (P) metric is calculated as:

$$P = \frac{{w}_{E} E + {w}_{S} S + {w}_{R} R + {w}_{D} D + {w}_{A} A + {w}_{T} T + {w}_{U} U}{{w}_{E} + {w}_{S} + {w}_{R} + {w}_{D} + {w}_{A} + {w}_{T} + {w}_{U}}$$

Having generated the main metric P and the sub-metrics E, S, R, D, A, T and U, the dispatcher or manager 113 can request 208 said data about the technician 110 and receive said performance data 210 about the technician from the server 102.

In step 318, the server 102 searches the attached database for one or more matching best practice instruction records with a main metric and sub-metrics that matches, within predefined parameters, the main metric that was calculated and the sub-metrics E, S, R, D, A, T and U. In step 320, the server 102 displays the description of a program for best practice instruction of the one or more matching best practice instruction records. Steps 318 and 320 meet the requirements of quality assurance because the purpose of said steps is to assure the quality of the data produced by the field technician in future performances. Quality assurance is a way of preventing mistakes or defects in the buried asset data points and avoiding problems associated with faulty or imprecise buried asset data points. Quality assurance comprises administrative and procedural activities implemented in a quality system so that requirements and goals for the buried asset data points are fulfilled.

FIG. 4 is an illustration showing the process of logging buried asset data points, according to an example embodiment. FIG. 4 shows that buried asset data points 402, 404, 406, 408, 410 were logged in a geographical area represented by the two dimensional area 400. In step 308, for example, session speed (S), which indicates an amount of time taken by the field technician to acquire the group, is calculated based on a time and date when first buried asset data point 402 of the group was taken, and a time and date when the last buried asset data point 410 of the group was taken.,

FIG. 5 is an illustration showing the process of calculating density of buried asset data points, according to an example embodiment. FIG. 5 shows that buried asset data points 402, 404, 406, 408, 410 were logged in a geographical area represented by the two dimensional area 500. In step 308, for example, record density (R), which indicates a density of the group within a geographical area, is calculated based on a number of buried asset data points in the group (i.e., 5 points) and a size of a smallest geographical area 510 in which said buried asset data points are located. For example, if area 510 measures 100 square feet, then record density (R) is calculated as 5 points per 100 square feet, or 1 point per 20 square feet. Note that although process 300 is described as having been performed by multiple entities, including device 102, the process 300 can be wholly performed by device 120 or 101.

FIG. 6 is a block diagram of a system including an example computing device 600 and other computing devices. Consistent with the embodiments described herein, the aforementioned actions performed by device 102, devices 120, 122, and locator 101 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for system 100 and process 300, as described above. Process 300 may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600′s operation. In one embodiment, programming modules 606 may include, for example, a program module 607 for executing the actions of device 102, devices 120, 122, and locator 101. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. Computing device 600 may also include a vibration device capable of initiating a vibration in the device on command, such as a mechanical vibrator or a vibrating alert motor. The aforementioned devices are only examples, and other devices may be added or substituted.

Computing device 600 may also contain a network connection device 615 that may allow device 600 to communicate with other computing devices 618, such as over a network in a distributed computing environment, for example, an intranet or the Internet. Device 615 may be a wired or wireless network interface controller, a network interface card, a network interface device, a network adapter or a LAN adapter. Device 615 allows for a communication connection 616 for communicating with other computing devices 618. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of the stages of the processes 200-500 as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

The claims:

1. A method on a computing device for measuring quality of a buried asset location procedure for quality assurance, the method comprising:
storing, in an attached database, a plurality of best practice instruction records, wherein each record includes a description of a program for best practice instruction, a main metric and one or more sub-metrics representing quality of a field technician's buried asset location procedure and technique, wherein said program for best practice instruction addresses educational and process deficiencies identified by said main metric and sub-metrics;
receiving, via a communications network communicatively coupled with the computing device, the following data from a field technician that has performed a buried asset location procedure: a) a group of buried asset data points corresponding to a particular buried asset, wherein each of said buried asset data points includes geographical location data and a time and date stamp, b) metadata pertaining to the group of buried asset data points, and c) a unique identifier for the field technician;
calculating the following sub-metrics based on the group of buried asset data points and said metadata: i) electromagnetic locate compliance (E), which indicates the field technician's compliance with predefined buried asset location procedure standard, ii) session speed (S), which indicates an amount of time taken by the field technician to acquire the group, iii) record density (R), which indicates a density of the group within a geographical area, iv) data quality (D), which indicates accuracy and precision of the group, v) useful additions (A), which includes written comments and images entered by the field technician and which correspond to the group, vi) travel time efficiency (T), which indicates an amount of time between reception of a ticket to locate the group and the time and date of acquisition of the group, and vii) utility type efficiency (U), which indicates an amount of time taken to locate each buried asset type;
for each of the sub-metrics E, S, R, D, A, T and U, defining a sigmoid function described by at least one quantity-value pair entered by an administrator, wherein a quantity-value pair comprises a quantity for a sub-metric paired with a resulting performance value;
converting each of the sub-metrics E, S, R, D, A, T and U to a normalized value by entering each sub-metric value into the sigmoid function corresponding to said sub-metric;
storing the following weight values: w_{E}, w_{S}, w_{R}, w_{D}, w_{A}, w_{T}, w_{U}, wherein w_{E} is a weight value corresponding to E, w_{S} is a weight value corresponding to S, w_{R} is a weight value corresponding to R, w_{D} is a weight value corresponding to D, w_{A} is a weight value corresponding to A, w_{T} is a weight value corresponding to T, and w_{U} is a weight value corresponding to U;
calculating a main metric P representing the quality of the field technician's buried asset location procedure and technique, wherein the main metric P is calculated as:
$$P = \frac{{w}_{E} E + {w}_{S} S + {w}_{R} R + {w}_{D} D + {w}_{A} A + {w}_{T} T + {w}_{U} U}{{w}_{E} + {w}_{S} + {w}_{R} + {w}_{D} + {w}_{A} + {w}_{T} + {w}_{U}}$$
searching the attached database for one or more matching best practice instruction records with a main metric and sub-metrics that matches, within predefined parameters, the main metric P that was calculated and the sub-metrics E, S, R, D, A, T and U; and
displaying the description of a program for best practice instruction of the one or more matching best practice instruction records.

2. The method of claim 1, wherein each best practice instruction record includes at least one instructional video for viewing by a field technician for which said record addresses educational and process deficiencies.

3. The method of claim 2, wherein the step of receiving via a communications network communicatively coupled with the computing device, further comprises receiving, via a communications network communicatively coupled with the computing device, data uploaded by a locate device of a field technician that has performed a buried asset location procedure.

4. The method of claim 3, wherein electromagnetic locate compliance (E), which indicates the field technician's compliance with predefined buried asset location procedure standard, is calculated by analyzing the following data collected from the field technician's locate device: operating modes, electromagnetic signal response data and on-board motion sensors.

5. The method of claim 4, wherein session speed (S), which indicates an amount of time taken by the field technician to acquire the group, is calculated based on a time and date when a first buried asset data point of the group was taken, and a time and date when a last buried asset data point of the group was taken.

6. The method of claim 5, wherein record density (R), which indicates a density of the group within a geographical area, is calculated based on a number of buried asset data points in the group and a size of a geographical area in which said buried asset data points are located.

7. The method of claim 6, wherein data quality (D), which indicates accuracy and precision of the group, is calculated based on a precision data value associated with the group of buried asset data points.

8. The method of claim 7, wherein travel time efficiency (T) is calculated based on an amount of time between reception of a ticket to locate the group and the time and date of acquisition of the last buried asset data point of the group.

9. The method of claim 8, wherein utility type efficiency (U), which indicates an amount of time taken to locate each buried asset type is calculated by measuring time taken to locate each type of buried asset.

10. The method of claim 9, wherein the sigmoid function comprises the hyperbolic tangent function.

11. A method on a computing device for measuring quality of a buried asset location procedure for quality assurance, the method comprising:
storing, in an attached database, a plurality of best practice instruction records, wherein each record includes a description of a program for best practice instruction, a main metric and one or more sub-metrics representing quality of a field technician's buried asset location procedure and technique, wherein said program for best practice instruction addresses educational and process deficiencies identified by said main metric and sub-metrics;
receiving, via a communications network communicatively coupled with the computing device, the following data from a field technician that has performed a buried asset location procedure: a) a group of buried asset data points corresponding to a particular buried asset, wherein each of said buried asset data points includes geographical location data and a time and date stamp, b) metadata pertaining to the group of buried asset data points, and c) a unique identifier for the field technician;
calculating the following sub-metrics based on the group of buried asset data points and said metadata: i) electromagnetic locate compliance (E), which indicates the field technician's compliance with predefined buried asset location procedure standard, ii) session speed (S), which indicates an amount of time taken by the field technician to acquire the group, iii) record density (R), which indicates a density of the group within a geographical area, iv) data quality (D), which indicates accuracy and precision of the group, v) useful additions (A), which includes written comments and images entered by the field technician and which correspond to the group, vi) travel time efficiency (T), which indicates an amount of time between reception of a ticket to locate the group and the time and date of acquisition of the group, and vii) utility type efficiency (U), which indicates an amount of time taken to locate each buried asset type;
for each of the sub-metrics E, S, R, D, A, T and U, defining a hyperbolic tangent sigmoid function described by at least one quantity-value pair derived from empirical data collected from a statistically relevant sample of other field technicians, wherein a quantity-value pair comprises a quantity for a sub-metric paired with a resulting performance value;
converting each of the sub-metrics E, S, R, D, A, T and U to a normalized value by entering each sub-metric value into the sigmoid function corresponding to said sub-metric;
storing the following weight values: w_{E}, w_{S}, w_{R}, w_{D}, w_{A}, w_{T}, w_{U}, wherein w_{E} is a weight value corresponding to E, w_{S} is a weight value corresponding to S, w_{R} is a weight value corresponding to R, w_{D} is a weight value corresponding to D, w_{A} is a weight value corresponding to A, w_{T} is a weight value corresponding to T, and w_{U} is a weight value corresponding to U;
calculating a main metric P representing the quality of the field technician's buried asset location procedure and technique, wherein the main metric P is calculated as:
$$P = \frac{{w}_{E} E + {w}_{S} S + {w}_{R} R + {w}_{D} D + {w}_{A} A + {w}_{T} T + {w}_{U} U}{{w}_{E} + {w}_{S} + {w}_{R} + {w}_{D} + {w}_{A} + {w}_{T} + {w}_{U}}$$
searching the attached database for one or more matching best practice instruction records with a main metric and sub-metrics that matches, within predefined parameters, the main metric P that was calculated and the sub-metrics E, S, R, D, A, T and U; and
displaying the description of a program for best practice instruction of the one or more matching best practice instruction records.

12. The method of claim 11, wherein each best practice instruction record includes at least one instructional video for viewing by a field technician for which said record addresses educational and process deficiencies.

13. The method of claim 12, wherein the step of receiving via a communications network communicatively coupled with the computing device, further comprises receiving, via a communications network communicatively coupled with the computing device, data uploaded by a locate device of a field technician that has performed a buried asset location procedure.

14. The method of claim 13, wherein electromagnetic locate compliance (E), which indicates the field technician's compliance with predefined buried asset location procedure standard, is calculated by analyzing the following data collected from the field technician's locate device: operating modes, electromagnetic signal response data and on-board motion sensors.

15. The method of claim 14, wherein session speed (S), which indicates an amount of time taken by the field technician to acquire the group, is calculated based on a time and date when a first buried asset data point of the group was taken, and a time and date when a last buried asset data point of the group was taken.

16. The method of claim 15, wherein record density (R), which indicates a density of the group within a geographical area, is calculated based on a number of buried asset data points in the group and a size of a geographical area in which said buried asset data points are located.

17. The method of claim 16, wherein data quality (D), which indicates accuracy and precision of the group, is calculated based on a precision data value associated with the group of buried asset data points.

18. The method of claim 17, wherein travel time efficiency (T) is calculated based on an amount of time between reception of a ticket to locate the group and the time and date of acquisition of the last buried asset data point of the group.

19. The method of claim 18, wherein utility type efficiency (U), which indicates an amount of time taken to locate each buried asset type is calculated by measuring time taken to locate each type of buried asset.

20. A system for measuring quality of a buried asset location procedure for quality assurance, the system comprising:
a database for storing a plurality of best practice instruction records, wherein each record includes a description of a program for best practice instruction, a main metric and one or more sub-metrics representing quality of a field technician's buried asset location procedure and technique, wherein said program for best practice instruction addresses educational and process deficiencies identified by said main metric and sub-metrics;
a mobile computing device communicatively coupled with the communications network, the mobile computing device configured for transmitting, via the communications network, the following data from a field technician that has performed a buried asset location procedure: a) a group of buried asset data points corresponding to a particular buried asset, wherein each of said buried asset data points includes geographical location data and a time and date stamp, b) metadata pertaining to the group of buried asset data points, and c) a unique identifier for the field technician;
a server communicatively coupled with the database and the communications network, the server configured for:
calculating the following sub-metrics based on the group of buried asset data points and said metadata: i) electromagnetic locate compliance (E), which indicates the field technician's compliance with predefined buried asset location procedure standard, ii) session speed (S), which indicates an amount of time taken by the field technician to acquire the group, iii) record density (R), which indicates a density of the group within a geographical area, iv) data quality (D), which indicates accuracy and precision of the group, v) useful additions (A), which includes written comments and images entered by the field technician and which correspond to the group, vi) travel time efficiency (T), which indicates an amount of time between reception of a ticket to locate the group and the time and date of acquisition of the group, and vii) utility type efficiency (U), which indicates an amount of time taken to locate each buried asset type;
for each of the sub-metrics E, S, R, D, A, T and U, defining a sigmoid function described by at least one quantity-value pair entered by an administrator, wherein a quantity-value pair comprises a quantity for a sub-metric paired with a resulting performance value;
converting each of the sub-metrics E, S, R, D, A, T and U to a normalized value by entering each sub-metric value into the sigmoid function corresponding to said sub-metric;
storing the following weight values: w_{E}, w_{S}, w_{R}, w_{D}, w_{A}, w_{T}, w_{U}, wherein w_{E} is a weight value corresponding to E, w_{S} is a weight value corresponding to S, w_{R} is a weight value corresponding to R, w_{D} is a weight value corresponding to D, w_{A} is a weight value corresponding to A, w_{T} is a weight value corresponding to T, and w_{U} is a weight value corresponding to U;
calculating a main metric P representing the quality of the field technician's buried asset location procedure and technique, wherein the main metric P is calculated as:
$$P = \frac{{w}_{E} E + {w}_{S} S + {w}_{R} R + {w}_{D} D + {w}_{A} A + {w}_{T} T + {w}_{U} U}{{w}_{E} + {w}_{S} + {w}_{R} + {w}_{D} + {w}_{A} + {w}_{T} + {w}_{U}}$$
searching the database for one or more matching best practice instruction records with a main metric and sub-metrics that matches, within predefined parameters, the main metric P that was calculated and the sub-metrics E, S, R, D, A, T and U; and
displaying the description of a program for best practice instruction of the one or more matching best practice instruction records.
